(19) United States
(12) Patent Application Publication
(10) Pub. No.: US 2010/0220422 A1
(43) Pub. Date: Sep. 2, 2010

(54) Circuit Protection Device

(76) Inventor: Keith Jackson, Oban (GB)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/681,266

(22) PCT Filed: Sep. 26, 2008
(86) PCT No.: PCT/GB08/03286

§ 371 Date: Apr. 1, 2010

(30) Foreign Application Priority Data
Oct. 2, 2007 (GB) 0719229.7

(51) Int. Cl. H02H 3/08; G06F 19/00

(52) U.S. Cl. 361/93.2; 702/66

(57) ABSTRACT

The present invention provides a circuit protection device for protecting an electrical circuit, the circuit protection device having a signal processing unit which includes a digital processor which is adapted to receive a digital signal I_{dig} which has a value representative of a current through an electrical path of an electrical supply, receive a digital signal V_{dig} which has a value representative of the voltage across the electrical path, and produce a digital signal I_{Rdig} which has a value representative of the real component of the current through the electrical path, based on the digital signals I_{dig} and V_{dig}.

This invention relates to the field of circuit protection devices and/or circuit breakers. In particular, this invention relates to residual current devices and miniature circuit breakers.

### BACKGROUND

Circuit protection devices are used to protect electrical supplies and electrical installations, e.g. to protect against damage and to reduce the risk of electrocution.

A subset of circuit protection devices are residual current devices (RCDs). An RCD is a device which disconnects an electrical supply whenever it detects that the flow of current is not balanced between the phase line and neutral line of an electrical supply. A current imbalance between the phase and neutral lines of the electrical supply is indicative of a fault current leaking from the electrical supply (e.g. to earth). RCDs disconnect the electrical supply whenever the fault current from the electrical supply exceeds a predetermined threshold (e.g. 30 mA). RCDs are used to reduce the risk of electrocution due to a fault current.

Conventional RCDs include a current transformer with the phase and neutral lines of the electrical supply passing therethrough (with the current in the phase and neutral lines flowing in opposite directions). When there is a current imbalance between the supply and neutral lines, magnetic flux is produced in the transformer core. When the magnetic flux exceeds a threshold (which is indicative of a fault current exceeding the predetermined threshold), the electrical supply is disconnected by an electrical relay.

UK patent application No GB-A-2258095 discloses an RCD which includes a phase sensitive detector, for making an RCD insensitive to capacitive leakage current and only sensitive to the resistive component of the leakage current.

Another subset of circuit protection devices are miniature circuit breakers (MCBs). An MCB is an automatic electrical switch which is designed to disconnect an electrical supply whenever the current through the phase line of the electrical supply exceeds a threshold value.

At its most general, this invention provides a circuit protection device for producing a digital signal which has a value representative of the real component of a current (sometimes referred to as the “active current”, “real current” or “resistive current”) through an electrical path of an electrical supply. The electrical path may be a fault path from the electrical supply (e.g. the fault path to earth). The electrical path may be a supply line of the electrical supply.

According to a first aspect, there may be provided a circuit protection device for protecting an electrical circuit, the circuit protection device having: a signal processing unit which includes a digital processor which is adapted to: receive a digital signal I_{dig} which has a value representative of a current through an electrical path of an electrical supply; receive a digital signal V_{dig} which has a value representative of the voltage across the electrical path; and produce a digital signal I_{Rdig} which has a value representative of the real component of the current through the electrical path, based on the digital signals I_{dig} and V_{dig}.

Therefore, the first aspect provides a circuit protection device which is able to digitally measure a value of the real component of a current (sometimes referred to as the “active current”, “real current” or “resistive current”) through an electrical path of an electrical supply. Conventional circuit protection devices only measure values representative of the total current (which may be referred to as the “apparent current”) in an electrical path of an electrical supply, not the real component of the current.

Measuring the real current in an electrical path of the electrical supply may be useful for a variety of reasons. For example, where the electrical path is a fault path from an electrical supply (e.g. where the device is a residual current device), it is advantageous to measure the real current, as the real current through the fault path is more dangerous than a reactive current through the fault path (e.g. since the real current represents a greater fire risk). As another example, the digital signal I_{Rdig} could be used for internal calculations by the digital processor. As yet another example, I_{Rdig} may be used by a technician, to provide him/her with diagnostic information about the electrical path of the electrical supply.

The electrical supply may be an AC electrical supply. It may be a mains AC electrical supply. The electrical supply may have a phase line (sometimes referred to as a “hot” or “live” line) and a neutral line.

The digital signal I_{Rdig} may be a value representative of the average real current component of the current through the electrical path, e.g. averaged over an AC cycle or over a plurality of AC cycles. This may help to guard against transient events. Preferably, the value is averaged over a plurality of AC cycles.

The circuit protection device may be a device which protects an electrical supply and/or an electrical installation, e.g. to protect against damage and to reduce the risk of electrocution.

The digital processor may be adapted to produce any one or more of: a digital signal V_{RMSdig} which has a value representative of the root mean squared voltage across said electrical path; a digital signal I_{RMSdig} which has a value representative of the root mean squared current through the electrical path; a digital signal I_{Adig} which has a value representative of the apparent current through the electrical path; a digital signal P_{Adig} which has a value representative of the apparent power of the current through the electrical path; a digital signal P_{Rdig} which has a value representative of the real power of the current through said electrical path; a digital signal k_{dig} which has a value representative of the power factor in the electrical path; and a digital signal θ_{dig} which has a value representative of the phase angle of the power in the electrical path.

These additional digital signals may be used internally by the digital processor for calculations in the circuit protection device (e.g. to calculate values of other digital signals). These additional signals may also be useful to provide diagnostic information to a technician.

The digital signals P_{R}, I_{Adig}, V_{RMSdig}, I_{RMSdig}, P_{Adig}, P_{Rdig}, k_{dig} and/or θ_{dig} may have values which are averaged, e.g. averaged over an AC cycle or over a plurality of AC cycles. This may help to guard against transient events.

Since I_{RMSdig} is representative of the average apparent current in the electrical path, a digital signal I_{RMSdig} may also be the digital signal I_{Adig}.

The digital processor may be adapted to: produce an interrupt signal INT_{R} for interrupting the continuity of the electrical supply when the value of the digital signal I_{Rdig} exceeds a threshold value I_{Rthresh}.

The digital processor may be adapted to: produce an interrupt signal INT_{A} for interrupting the continuity of the electrical supply when the value of the digital signal I_{Adig} exceeds a threshold value I_{Athresh}. The interrupt signal INT_{R} may be the same as the interrupt signal INT_{A}. The interrupt signals INT_{R}, INT_{A} may be digital signals, they may be analogue signals.

The circuit protection device may additionally have interrupting means adapted to interrupt the continuity of the electrical supply (e.g. to disconnect or break the electrical supply) when an interrupt signal (e.g. the interrupt signal INT_{R} and/or the interrupt signal INT_{A}) is produced. Therefore, the electrical supply can be prevented from supplying power when the real and/or apparent current through the electrical path exceeds a threshold value. The interrupting means may include an actuator and a trip mechanism.

The electrical path may be a fault path from said electrical supply. A fault path is an electrical path through which current is leaked from the electrical supply. The fault path may be an electrical leakage path to earth. The current protection device may therefore interrupt the electrical supply when a real and/or apparent fault current exceeds a threshold value. Therefore, the circuit protection device may be a residual current device (RCD). In particular, the residual current device may be a residual current circuit breaker (RCCB) or residual current circuit breaker with over current protection (RCBO). The RCD may be adapted to interrupt the continuity of the electrical supply if the real and/or apparent current exceeds a threshold value for more than a predetermined duration.

When the circuit protection device is an RCD, the threshold value I_{Rthresh} may be in the range 6 mA to 2 Amps, e.g. to correspond to threshold values typically used in the US. The threshold value I_{Rthresh} may be in the range 10 mA to 500 mA, e.g. to correspond to threshold values typically used in IEC (International Electrotechnical Commission) countries such as the UK, the EU, South East Asia and Australasia. Similarly, the threshold value I_{Athresh} may be in the range 6 mA to 2 Amps and may be in the range 10 mA to 500 mA.

The residual current device may additionally have a sensing means for providing an analogue signal Iₐₙ representative of the current through said fault path to the signal processing unit, based on a current imbalance in the phase and neutral lines of an electrical supply. The sensing means may be a current transformer. The current transformer may have: a toroid for passing the phase and neutral lines of an electrical supply therethrough; and a sensing coil for winding around said toroid, for producing a current based on said current imbalance in the phase and neutral lines of the electrical supply.

The residual current device may have at least one electrical connector for connecting to the phase and neutral lines of the electrical supply respectively, for providing at least one analogue signal Vₐₙ representative of the voltage across a fault path to the signal processing unit. There may be two of the electrical connectors.

The residual current device may additionally have a power supply, for powering the signal processing unit. The power supply may be adapted to be powered by connecting it to the phase and neutral lines of the electrical supply (e.g. by electrical connectors, such as wires).

The electrical path of the electrical supply may be a supply line of an electrical supply (e.g. a phase line or a neutral line). In this case, the circuit protection device may interrupt the continuity of the electrical supply when the real and/or apparent current through a phase line exceeds a threshold value (as described previously). Therefore, the circuit protection device may be a miniature circuit breaker (MCB). The MCB may be adapted to interrupt the continuity of the electrical supply if the real and/or apparent current exceeds a threshold value for more than a predetermined duration.

When the circuit protection device is an MCB, the threshold value I_{Rthresh} may be in the range 0.5A to 32A, e.g. to correspond to threshold values typically used for MCBs. The threshold value I_{Athresh} may be in the range 0.5A to 32A.

The digital processor may be adapted to produce the digital signal I_{Rdig} by dividing the value of the digital signal P_{Rdig} by the value of the digital signal V_{RMSdig} (see Equation 5 in the “Background Theory” section).

The digital processor may have one or more digital infinite impulse response filters (IIRs). The IIRs may be used to perform averaging calculations. The IIR filters may be filters which output a signal which has a value which is approximately the time averaged value or time averaged MS (mean square) value or time averaged RMS (root mean square) value of the input signal. Suitably, the digital IIR filters are implemented by software, using algorithms which may be those known in the art. The time constant of the IIR filters may be selected so that the IIR filters average the input signal over an AC cycle or over a plurality of AC cycles.

An advantage of using digital IIR filters is to reduce the number of calculations required. Another advantages is that digital IIR filters can easily be implemented in hardware. A further advantage is that a digital IIR filter can guard against transient events giving spurious results.

The production of V_{RMSdig} by the digital processor may include passing the digital signal V_{dig} (or a derivative thereof) through a digital infinite impulse response filter. In particular, the digital processor may be adapted to produce the digital signal V_{RMSdig} by: producing a digital signal V_{Sdig} which has a value representative of the squared voltage across the electrical path by squaring the value of the digital signal V_{dig}; passing the digital signal V_{Sdig} through a digital infinite impulse response filter to produce a digital signal V_{MSdig} which has a value representative of the mean squared voltage across the electrical path; and applying a square root operation to the digital signal V_{MSdig}.

The production of I_{RMSdig} by the digital processor may include passing the digital signal I_{dig} (or a derivative thereof) through a digital infinite impulse response filter. In particular, the digital processor may be adapted to produce the digital signal I_{RMSdig} by: producing a digital signal I_{Sdig} which has a value representative of the squared current through the electrical path by squaring the value of the digital signal I_{dig}; passing the digital signal I_{Sdig} through a digital infinite impulse response filter to produce a digital signal I_{MSdig} which has a value representative of the mean squared current through the electrical path; and applying a square root operation to the digital signal I_{MSdig}.

The digital processor may be adapted to produce the digital signal P_{Adig} by multiplying the value of the digital signal I_{RMSdig} by the value of the digital signal V_{RMSdig} (see Equation 3 in the “Background Theory” section).

The digital processor may be adapted to produce the digital signal P_{Rdig} by: producing a digital signal IV_{dig} (which may be representative of instantaneous power) by multiplying the value of the digital signal V_{dig} by the value of the digital signal I_{dig}; and passing the digital signal IV_{dig} (or a derivative thereof) though a digital infinite impulse response filter (see Equation 4 in the “Background Theory” section).

The digital processor may be adapted to update (or sample) the digital signals I_{dig} at a first frequency, V_{dig} at a first frequency, and optionally IV_{dig} at a first frequency. The first frequencies at which these signals are updated (or sampled) are preferably the same frequency. I_{dig} and V_{dig} are preferably updated at the same times to produce IV_{dig} accurately. The values of the digital signals may be updated (or sampled) by an analogue to digital converter. The first frequencies are preferably greater than 1 kHz, so as to enable the digital processor to model the current and voltage (e.g. a 50 Hz mains current) with good accuracy.

The digital processor may be adapted to update (or sample) the digital signal I_{Rdig} at a second frequency, and optionally any one or more of I_{Adig} at a second frequency, V_{RMSdig} at a second frequency, I_{RMSdig} a second frequency, P_{Adig} at a second frequency, P_{Rdig} at a second frequency, k_{dig} at a second frequency and/or θ_{dig} at a second frequency. The second frequencies may be the same frequency so that the signals are updated (or sampled) at the same frequency.

The signal or signals which are updated (or sampled) at the second frequency may be averaged, e.g. by an IIR filter. Therefore, the second frequencies (or frequency) may be less than the first frequency, to reduce the number of computation steps. By updating (or sampling) any one or more of the signals I_{Rdig}, I_{Adig}, V_{RMSdig}, I_{RMSdig}, P_{Adig}, P_{Rdig}, k_{dig} and/or θ_{dig} less often, the number of calculations required is reduced and implementation in hardware is made easier. The second frequencies (or frequency) may be in the range 50 Hz to 120 Hz. A preferred second frequency is 100 Hz (once every 10 ms, which is once per voltage zero-crossing for a 50 Hz AC electrical supply).

The digital processor may be a microprocessor.

The signal processing unit may additionally have a first analogue to digital converter adapted to: receive an analogue signal Iₐₙ representative of the current through said electrical path; and produce the digital signal I_{dig} based on the analogue signal Iₐₙ, for receiving in the digital processor. The signal processing unit may additionally have a first amplifier adapted to amplify the analogue signal Iₐₙ before it is received by the analogue to digital converter. The first amplifier may be a programmable gain amplifier.

The signal processing unit may additionally have a second analogue to digital converter adapted to: receive at least one analogue signal Vₐₙ representative of the voltage across said electrical path; and produce at least one digital signal V_{Xdig} based on the at least one analogue signal Vₐₙ, for receiving in the digital processor. The thus produced digital signal V_{Xdig} may be the digital signal V_{dig}. Alternatively, the at least one digital signal V_{Xdig} may be used to produce V_{dig} in the digital processor. The signal processing unit may additionally have one or more amplifiers adapted to amplify or deamplify the at least one analogue signal Vₐₙ before it is received by the second analogue to digital converter. The amplifier may be a fixed gain amplifier. The amplifier (for deamplification) may be a resistive voltage divider.

The at least one analogue signal Vₐₙ may be obtained by providing at least one electrical connector between the electrical supply and the signal processing unit.

As shown by Equation 5 in the “Background Theory” section, the value of the digital signal P_{Rdig} may be proportional to the value of the digital signal I_{Rdig} (where V_{RMS} is constant). Accordingly, the digital signal P_{Rdig} can be considered as having a value representative of the real component of current through the electrical path. Therefore, P_{Rdig} may be used as the digital signal I_{Rdig}, e.g. for the purposes of producing an interrupt signal INT_{R}.

The electrical supply may be a three phase AC electrical supply. The digital processor may be adapted top produce the digital signals I_{Rdig}, V_{RMSdig}, I_{RMSdig}, I_{Adig}, P_{Adig}, P_{MRdig}, k_{dig} and/or θ_{dig} for each phase of the three phase electrical supply, in a manner previously described. This allows for measuring the real current component of each phase of the three phase electrical supply. Where the device functions as an RCD or an MCB, the interrupt signals INT_{R} and/or INT_{A} may be produced on the basis of any phase of the electrical supply.

According to a second aspect, there is provided a digital processor and/or signal processing unit as set out above.

According to a third aspect, there is provided a method of operating a circuit protection device, signal processing unit or a digital processor as set out above.

According to a fourth aspect, there is provided a device for measuring a current through an electrical path, the device having a signal processing unit which includes a digital processor which is adapted to: receive a digital signal I_{dig} which has a value representative of the current through the electrical path; receive a digital signal V_{dig} which has a value representative of the voltage across the electrical path; and produce a digital signal I_{Rdig} which has a value representative of the real component of the current through the electrical path, based on the digital signals I_{dig} and V_{dig}. The device may contain any of the features described in reference to the circuit protection device described above.

The term “is adapted to” with reference to this invention may be used interchangeably with “has means for”.

Embodiments of our proposals are discussed below, with reference to the accompanying drawings in which:

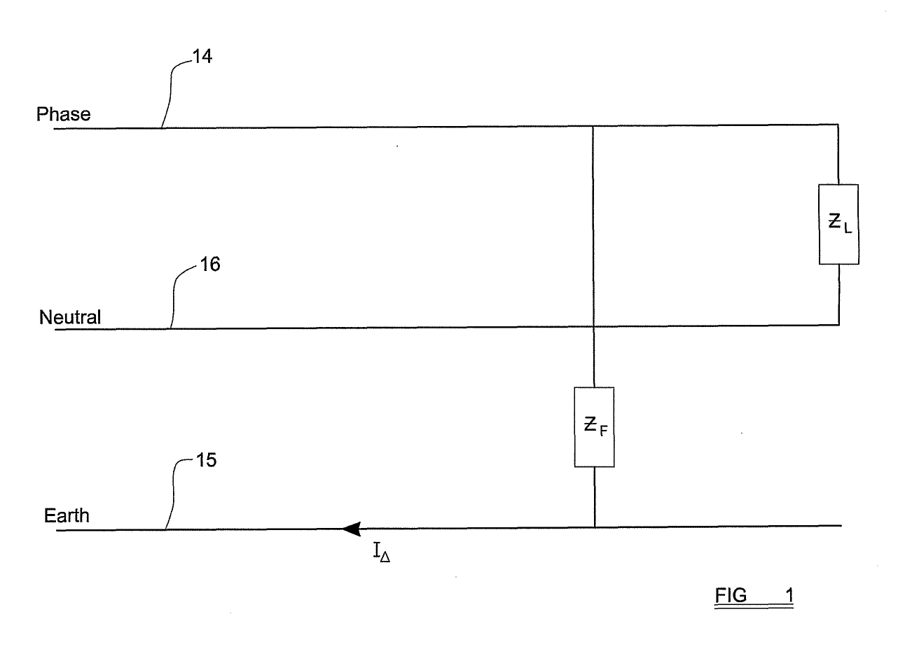

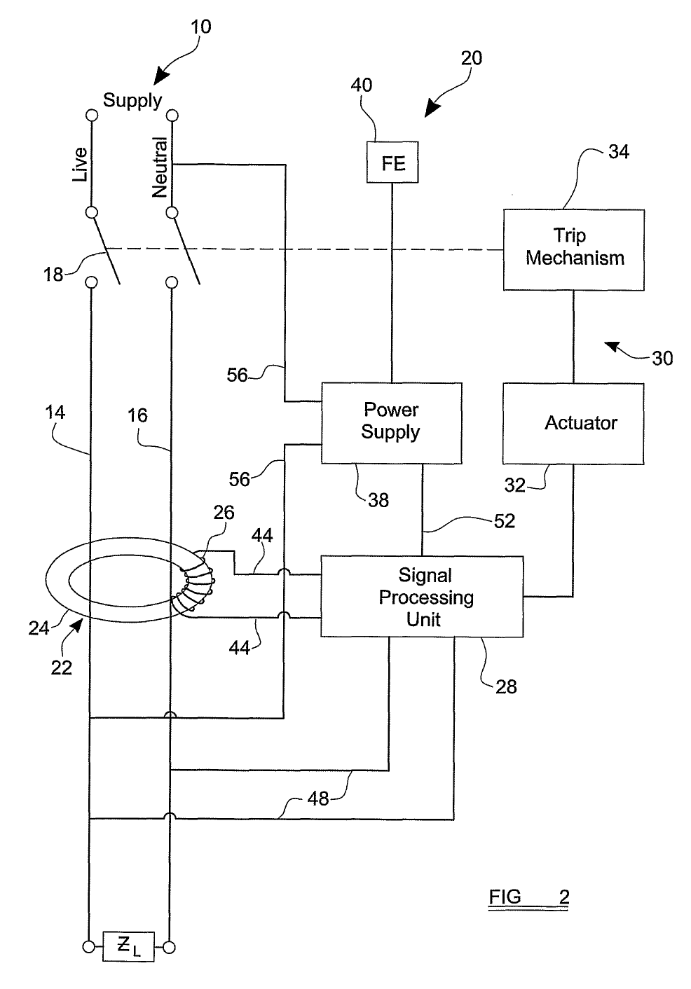

FIG. 1 shows a fault path from an AC electrical supply.

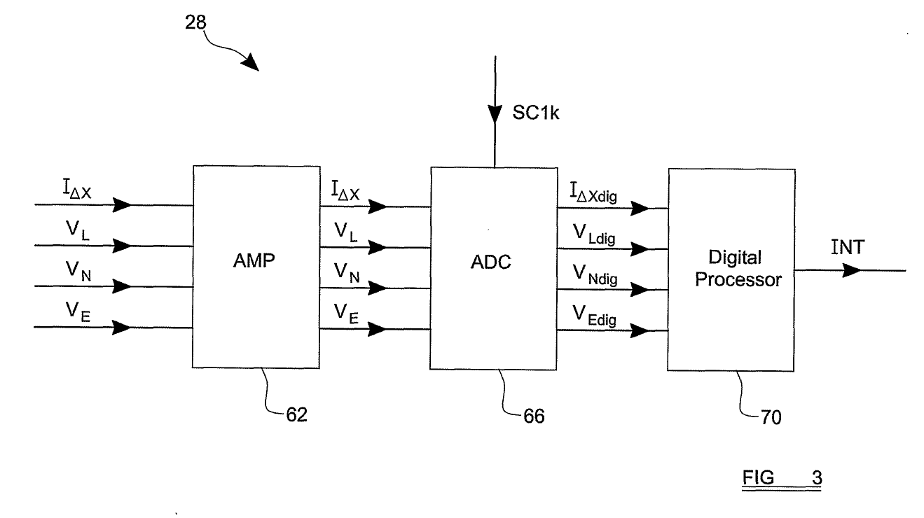

FIG. 2 shows an RCD arranged to monitor the AC electrical supply of FIG. 1.

FIG. 3 shows a signal processing unit of the RCD of FIG. 2.

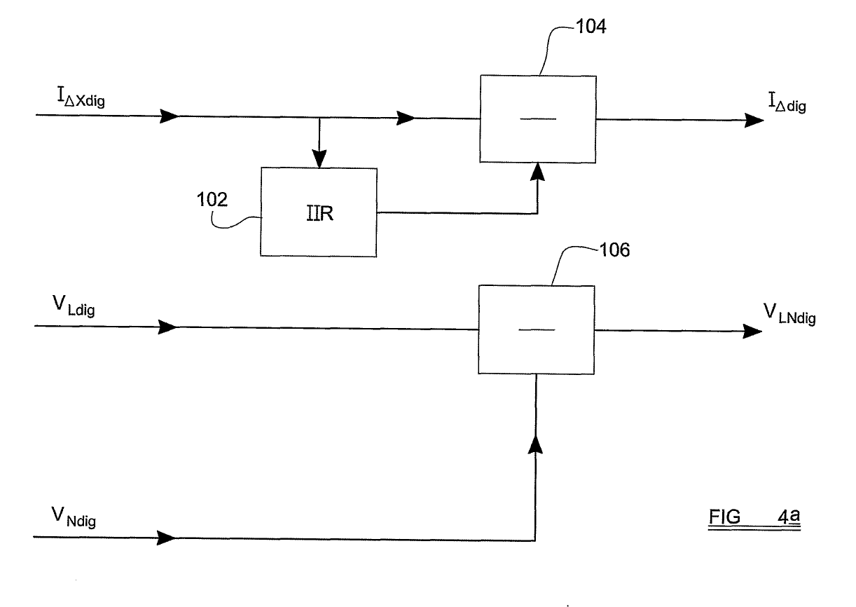

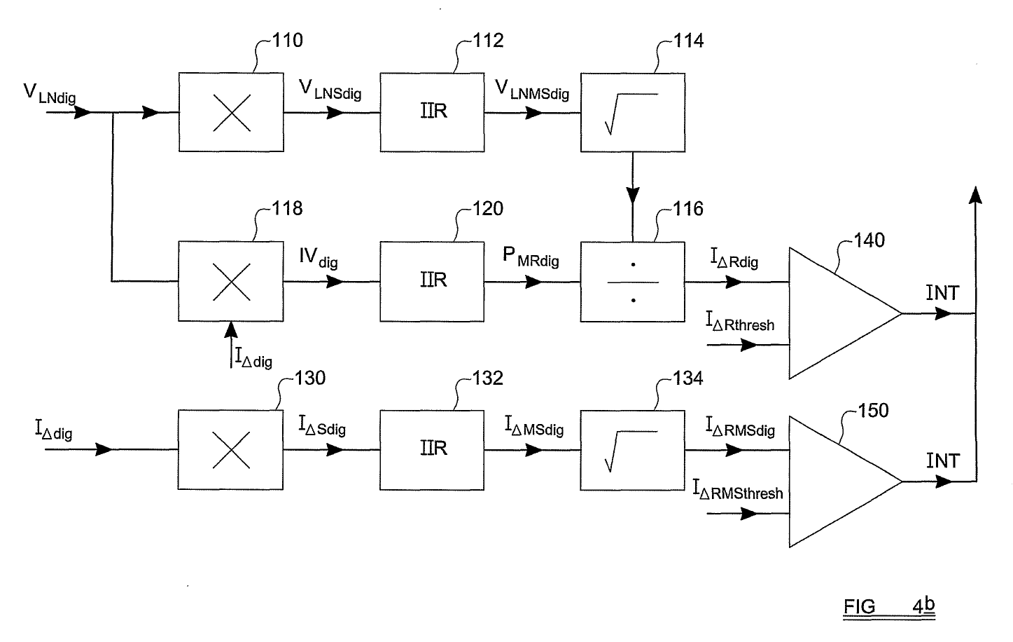

FIGS. 4a and 4b show a processing algorithm of the digital processor of the signal processing unit of FIG. 3.

FIG. 1 shows a fault path from an electrical AC supply 10, the electrical AC supply 10 having a phase line 14 (sometimes referred to as the “supply”, “live” or “hot” line) and a neutral line 16. An electrical load Z_{L} (e.g. an electrical appliance or circuit) is connected to the phase and neutral lines 14, 16. The fault path from the electrical AC supply 10 is represented by an impedance Z_{F} between the phase line 14 and earth 15. The fault impedance Z_{F} will give rise to a fault current I_{Δ} between the phase line 14 and earth 15.

If the fault impedance Z_{F} (i.e. the impedance of the fault path) is solely reactive, then the fault current I_{Δ} will be solely reactive (i.e. a “reactive” or “imaginary” fault current) so will be 90° out of phase with the supply voltage. When the fault current I_{Δ} is solely reactive, no energy is dissipated by the fault impedance Z_{F}.

If the fault impedance Z_{F} is solely real (resistive) then the fault current I_{Δ} will be solely real, and so the fault current will be exactly in phase with the supply voltage. When the fault current I_{L} is real, there is energy dissipated by the fault impedance Z_{R}.

In practice, the fault impedance Z_{F} will have a real component (i.e. the “real”, “active” or “resistive” current) and a reactive component (i.e. the “imaginary” current). Therefore, the total fault current I_{Δ} will consist of a real fault current I_{ΔR} which is in phase with the supply voltage and a reactive fault current I_{Δi} which is 90° out of phase with the supply voltage. The total fault current I_{Δ} may be referred to as the “apparent” fault current, as it is not representative of the real fault current I_{ΔR}.

It has been found that the real fault current I_{ΔR} represents a much greater danger than the reactive fault current I_{Δi}. For example, because the real fault current I_{ΔR} dissipates energy in the fault impedance Z_{R}, it poses a risk of fire. Also, the human body is largely resistive, therefore a fault current with a predominantly real component is produced in the event of an electrocution.

Fault currents I_{Δ} are commonly found to be reactive, e.g. due to capacitive coupling to earth, particularly by suppression devices. Although not necessarily dangerous, a relatively small reactive fault current can cause a conventional RCD to trip. This is because conventional RCDs are only sensitive to the magnitude of the total fault current I_{Δ} (i.e. the apparent current) and are therefore unable to distinguish between a (more dangerous) real fault current I_{ΔR} and a (less dangerous) reactive fault current I_{66 i}.

It is thought that by developing an RCD which is sensitive to the real fault current I_{ΔR}, it will be possible to avoid unnecessary tripping due non-dangerous reactive fault currents I_{Δi} caused by nearby reactive impedances Z_{F}, such as suppression capacitors.

Accordingly, FIG. 2 shows a residual current device (RCD) 20 arranged to monitor the electrical AC supply 10 of FIG. 1. The electrical AC supply 10 includes openable contacts 18 in the phase and neutral lines 14, 16. The RCD 20 has a current transformer 22, a signal processing unit 28, an interrupting means 30 and a power supply 38.

The current transformer 22 has a toroid 24 and a sensing coil 26. The phase and neutral lines 14, 16 of the electrical AC supply 10 (which act as a primary winding for the transformer 22) pass through the toroid 24. When there is no fault path (i.e. Z_{F}=0), the currents through the phase and neutral lines 14, 16 are equal and so no magnetic flux is generated in the toroid 24. When there is a fault path (i.e. Z_{F} is non-zero), there is a current imbalance I_{Δ} between the phase and neutral lines 14, 16 which cause magnetic flux to be produced in the toroid 24. The magnetic flux produced in the toroid 24 produces a current I_{Δx} in the sensing coil 26 (which acts as a secondary winding for the transformer 20). The thus produced current I_{Δx} is representative of the fault current I_{Δ} of the electrical AC supply 10, and is received in the signal processing unit 28 via electrical connectors 44 (which may be wires).

A pair of electrical connectors 48 connect the phase and neutral lines 14, 16 of the electrical AC supply 10 to the signal processing unit 28, to provide analogue signals representative of the phase voltage V_{L} and the neutral voltage V_{N} of the electrical AC supply 10 to the signal processing unit 28. Another connector (not shown) connects the signal processing unit 28 to earth, to provide the earth voltage V_{E} to the signal processing unit 28.

The interrupting means 30 has an actuator 32 and a trip mechanism 34. The interrupting means 30 is adapted to interrupt the continuity of the electrical AC supply 10 by opening contacts 18 (i.e. disconnecting the power supply) when the signal unit 28 produces an interrupt signal INT.

The power supply 38 powers the signal processing unit 28. The power supply is powered by the electrical supply 20, via connectors 56. In this example, the power supply is also connected to a functional earth 40 (FE) which allows the electronics to be powered between line and earth whenever the neutral phase is lost (as is acceptable in certain countries, e.g. UK, Ireland, Holland).

FIG. 3 is a symbolic representation showing the signal processing of the signal processing unit 28. As described previously, the signal processing unit 28 receives four analogue signals I_{Δx}, V_{L}, V_{N}, V_{E}, these signals being representative of the fault current (I_{Δx}), the phase voltage (V_{L}) the neutral voltage (V_{N}) and the earth voltage (V_{E}) respectively. The signals undergo an initial amplification step in amplifier unit 62. Any suitable amplification may be used. In this example, resistive voltage dividers are used to deamplify the voltage signals (V_{L}, V_{N}, V_{E}). The current signal (I_{Δx}) is amplified to increase its strength by a programmable gain amplifier.

The current I_{Δx} produced by the current transformer 22 may have a very wide dynamic range (e.g. if the winding ratio of the current transformer was 1000:1, I_{Δx} could be in the range 1 μA to 25 mA). Therefore, the amplification of I_{Δx} in this example is performed by a programmable gain amplifier, so that the dynamic range of the resulting signal I_{Δx} is reduced. This makes it easier to convert I_{Δx} into a digital signal (the analogue to digital conversion is described below).

After amplification, the signals I_{Δx}, V_{L}, V_{N}, V_{E} undergo analogue to digital conversion in an analogue to digital converter unit (ADC) 66 to produce digital signals I_{ΔXdig}, V_{Ldig}, V_{Ndig}, V_{Edig} which have values representative of the fault current (I_{ΔXdig}), phase voltage (V_{Ldig}), neutral voltage (V_{Ndig}) and earth voltage (V_{Edig}) respectively. The ADC 66 may be of any suitable type (e.g. Delta Sigma or SAR type) but in this example is a SAR (successive approximation) type ADC.

ADC 66 receives a clock signal SClk which dictates the sampling rate of the ADC 66. The sampling rate is determined by the desired frequency response and the number of signals (“channels”) to be measured. Suitably, for a 50 Hz mains supply, the sample rate for the ADC 66 is over 1 kHz, and may be in the range 2 KHz to 4 KHz. The signals I_{Δdig}, V_{Ldig}, V_{Ndig} and V_{Edig} from the ADC 66 are subsequently inputted to a digital processor 70 for processing. Although V_{Edig} is not used in this embodiment, it may be used for other calculations.

In an embodiment where a three phase electrical supply is used, there may be additional voltages lines connected to the signal processing unit 28 to carry the respective phases of the electrical supply.

FIGS. 4a and 4b illustrate the processing algorithm of digital processor 70 of the signal processing unit 28.

In FIG. 4a, the digital signal I_{ΔXdig} undergoes offset correction by a lowpass digital IIR filter 102 and subtract operation 104. The digital IIR filter 102 is a low pass filter which removes any fault signal leaving the average DC value present in the measured signal. This DC value is subtracted from I_{ΔXdig} to correct for any offsets. The digital signals V_{Ldig} and V_{Ndig} undergo a subtract operation 106 to produce digital signal V_{LNdig} which is representative of the phase-neutral voltage (V_{LNdig}) of the electrical AC supply 10. The digital signals I_{Δdig} and V_{LNdig} have values which are representative of the current and voltage of the fault current I_{Δ} through the fault path from electrical AC supply 10.

The processing algorithm shown in FIG. 4b includes digital IIR filters 112, 120, 132. The digital IIR filters 112, 120, 132 are filters which output a signal which has a value which is approximately the time averaged value of the input signal. The time constant of the IIR filters is selected so that the IIR filters average the input signal over an AC cycle of the electrical AC supply 10. The averaging by the IIR filters helps to reduce the number of computation steps and guards against transient events giving spurious results.

In the process shown in FIG. 4b, V_{LNdig} undergoes a multiply operation 110 where it is multiplied by itself to produce a signal V_{LNSdig} representative of the squared voltage in the fault path. V_{LNSdig} is then passed through a digital IIR filter 112 which averages the value of V_{LNSdig} to produce a digital signal V_{LNMSdig} representative of mean squared voltage in the fault path over an AC cycle. V_{LNMSdig} then undergoes a square root operation 114 to produce a digital signal V_{LNRMSdig} having a value representative of the root mean squared voltage of the fault current (see Equation 2 in the “Background Theory” section).

In another processing branch, V_{LNdig} undergoes a multiplication operation 118 with I_{Δdig}, where the value of V_{LNdig} is multiplied by the value of I_{Δdig}, to produce a signal IV_{dig} representative of the instantaneous real power in the fault path. IV_{dig} is passed through a digital IIR filter 120 to produce a digital signal P_{MRdig} which has a value representative of the mean (i.e. average) real power in the fault path over an AC cycle (see Equation 4 in the “Background Theory” section).

The produced signals P_{MRdig} and V_{LNRMSdig} subsequently undergo a divide operation 116, whereby the value of P_{MRdig} is divided by V_{LNRMSdig} to produce a digital signal I_{ΔRdig} which has a value representative of the average real fault current I_{ΔR} (i.e. the average real component of the fault current I_{ΔR}) through the fault path (see Equation 5 in the “Background Theory” section).

A comparator 140 compares the value of I_{ΔRdig} with a threshold value I_{ΔRthresh}. When the value of I_{ΔRdig} exceeds the threshold value I_{ΔRthresh}, the comparator 140 produces a signal INT, which instructs the interrupting means 30 to interrupt the continuity of (i.e. disconnect) the electrical AC supply 10.

Therefore, RCD 20 interrupts the continuity of the electrical AC supply 10 when the real current I_{ΔR} exceeds I_{ΔRthresh}. The threshold I_{ΔRthresh} may be set to a value at which the real fault current becomes dangerous (e.g. 10 mA). Because the comparator 140 is insensitive to reactive fault currents I_{Δi}, it is possible for the threshold I_{ΔRthresh} to be set at a low value (e.g. 10 mA), whilst avoiding unnecessary tripping due to a non-dangerous reactive fault current I_{Δi}. This is not possible in conventional RCDs, which trip according to an apparent current threshold.

In another processing branch, I_{Δdig} undergoes a multiplication operation 130, is passed through a digital IIR filter 132 and then undergoes a square root function 134 to produce a digital signal I_{ΔRMSdig} which has a value representative of the root mean squared current through the fault path (I_{ΔRMSdig} is produced in the same way as V_{LNRMSdig}). I_{ΔRMSdig} is phase insensitive and representative of the apparent fault current.

A comparator 150 compares the value of I_{ΔRMSdig} with a threshold value I_{ΔRMSthresh}. When the value of I_{ΔRMSdig} exceeds the threshold value I_{ΔRMSthresh}, the comparator 150 produces a signal INT, which instructs the interrupting means 30 to interrupt the continuity of the electrical AC supply 10.

Because I_{ΔRMSdig} is phase insensitive, the comparator 150 cannot distinguish between a real and a reactive fault current I_{Δ}. Therefore, the comparator 150 may produce an interrupt signal INT, even if the fault current I_{Δ} is purely reactive. Therefore, the threshold I_{ΔRMSthresh} may be set to be relatively high (e.g. 30 mA) compared to the threshold I_{ΔRthresh}, so as to avoid unnecessary tripping due to a small non-dangerous reactive fault current I_{Δi}. Nonetheless, the comparator 150 may be useful as it allows tripping when there is a large reactive fault current I_{Δi} (since this would not be detected by the comparator 140).

Operations 114, 116, 140, 134, 150 are all carried out on signals which have been IIR filtered. The signals that have been IIR filtered have been averaged over several AC cycles and therefore change on a much slower timescale than those signals which are not averaged over a cycle (e.g. I_{Δdig}, V_{INdig} and IV_{dig}). Therefore, it is unnecessary to carry out operations 114, 116, 140, 134, 150 at the same sampling rate as the ADC 66 (i.e. 2 kHz to 4 kHz). Instead, the operations 114, 116, 140, 134, 150 are only carried out at every voltage zero-cross (twice per AC cycle, which is every 10 ms for a 50 Hz supply), so as to save on the number of computation steps.

A particular advantage of the RCD 20 over prior devices (such as the one shown in GB-A-2258095) is that it can evaluate a fault current having any wave shape (not just sinusoidal waveforms).

One of ordinary skill after reading the foregoing description will be able to affect various changes, alterations, and subtractions of equivalents without departing from the broad concepts disclosed. It is therefore intended that the scope of the patent granted hereon be limited only by the appended claims, as interpreted with reference to the description and drawings, and not by limitation of the embodiments described herein.

### Background Theory

For an AC current through an impedance Z, the root mean squared current I_{RMS} can be calculated as:

$${I}_{RMS} = \sqrt{\frac{{\sum }_{n = 0}^{N - 1} {i}_{n}^{2}}{N}} \qquad ( 1 )$$

where N is the sample number, and iₙ is the nth measurement of current through the impedance Z.

Similarly, the root mean squared voltage can be calculated as:

$${V}_{RMS} = \sqrt{\frac{{\sum }_{n = 0}^{N - 1} {v}_{n}^{2}}{N}} \qquad ( 2 )$$

where vₙ is the nth measurement of voltage.

The values I_{RMS} and V_{RMS} are phase insensitive, i.e. they do not provide any information as to the phase relationship between the current and voltage of the current through the impedance. The apparent power P_{A} of the current through impedance Z can be calculated by multiplying I_{RMS} and V_{RMS} together. However, this value is also phase insensitive:

P_{A}=I_{RMS}V_{RMS} (3)

The real power P_{R} of the AC current through impedance Z is the measurement of the actual power dissipated in the impedance and is phase sensitive. It can be calculated by multiplying the instantaneous values for current and voltage (the instantaneous power) and averaging the resulting figure an AC cycle. The real power P_{R} can be found using the equation:

$${P}_{R} = \frac{{\sum }_{n = 0}^{N - 1} {v}_{n} {i}_{n}}{N} \qquad ( 4 )$$

The real current I_{R} through the impedance can be found by dividing the real power by V_{RMS}:

$${I}_{R} = \frac{{P}_{R}}{{V}_{RMS}} \qquad ( 5 )$$

It is also possible to calculate the power factor, k and the phase angle θ, using the following equation:

$$k = \frac{{P}_{R}}{{P}_{A}} = cos θ \qquad ( 6 )$$

1. A circuit protection device for protecting an electrical circuit, the circuit protection device having:
a signal processing unit which includes a digital processor which is adapted to:
receive a digital signal I_{dig} which has a value representative of a current through an electrical path of an electrical supply;
receive a digital signal V_{dig} which has a value representative of the voltage across the electrical path; and
produce a digital signal I_{Rdig} which has a value representative of the real component of the current through the electrical path, based on the digital signals I_{dig} and V_{dig}.

2. A circuit protection device according to claim 1 wherein the digital processor is adapted to produce any one or more of:
a digital signal V_{RMSdig} which has a value representative of the root mean squared voltage across the electrical path;
a digital signal I_{RMSdig} which has a value representative of the root mean squared current through the electrical path;
a digital signal I_{Adig} which has a value representative of the apparent current through the electrical path;
a digital signal P_{Adig} which has a value representative of the apparent power of the current through the electrical path;
a digital signal P_{Rdig} which has a value representative of the real power of the current through the electrical path;
a digital signal k_{dig} which has a value representative of the power factor in the electrical path; and
a digital signal θ_{dig} which has a value representative of the phase angle of the power in the electrical path.

3. A circuit protection device according to claim 1 wherein the digital processor is adapted to:
produce an interrupt signal INT_{R} for interrupting the continuity of the electrical supply when the value of the digital signal I_{Rdig} exceeds a threshold value I_{Rthresh}.

4. A circuit protection device according to claim 1 wherein the digital processor is adapted to:
produce a digital signal I_{Adig} which has a value representative of the apparent current through the electrical path;
produce an interrupt signal INT_{A} for interrupting the continuity of the electrical supply when the value of the digital signal I_{Adig} exceeds a threshold value I_{Athresh}.

5. A circuit protection device according to claim 3 additionally having interrupting means adapted to interrupt the continuity of the electrical supply when an interrupt signal is produced by the digital processor, wherein the interrupting means includes an actuator and a trip mechanism.

6. (canceled)

7. A circuit protection device according to claim 3 wherein the circuit protection device is a residual current device and the electrical path is a fault path from the electrical supply.

8. A residual current device according to claim 7 wherein the threshold value I_{Rthresh} and/or the threshold value I_{Athresh} is in the range 6 mA to 2A.

9. (canceled)

10. A residual current device according claim 7 additionally
having a sensing means for providing an analogue signal Iₐₙ representative of the current through the fault path to the signal processing unit, based on a current imbalance in the phase and neutral lines of the electrical supply, the sensing means being a current transformer having:
a toroid for passing the phase and neutral lines of the electrical supply therethrough; and
a sensing coil for winding around said toroid, for producing a current based on said current imbalance in the phase and neutral lines of the electrical supply.

11. (canceled)

12. (canceled)

13. A residual current device according to claim 7 additionally having:
at least one electrical connector for connecting to the phase and neutral lines of the electrical supply respectively, for providing at least one analogue signal Vₐₙ representative of the voltage across the fault path to the signal processing unit.

14. A residual current device according to claim 7 additionally
having a power supply, for powering the signal processing unit, wherein the power supply is adapted to be powered by connecting it to the phase and neutral lines of the electrical supply.

15. (canceled)

16. A circuit protection device according to claim 3 wherein the circuit protection device is a miniature circuit breaker and the electrical path is a supply line of the electrical supply.

17. (canceled)

18. (canceled)

19. A circuit protection device according to claim 2 wherein the digital processor is adapted to produce the digital signal I_{Rdig} by dividing the value of the digital signal P_{Rdig} by the value of the digital signal V_{RMSdig} and is further adapted to produce the digital signal V_{RMSdig} by:
producing a digital signal V_{Sdig} which has a value representative of the squared voltage across the electrical path by squaring the value of the digital signal V_{dig};
passing the digital signal V_{Sdig} through a digital infinite impulse response filter to produce a digital signal V_{MSdig} which has a value representative of the mean squared voltage across the electrical path; and
applying a square root operation to the digital signal V_{MSdig}.

20. (canceled)

21. A circuit protection device according to claim 2 wherein the digital processor is adapted to produce the digital signal I_{RMSdig} by:
producing a digital signal I_{Sdig} which has a value representative of the squared current through the electrical path by squaring the value of the digital signal I_{dig};
passing the digital signal I_{Sdig} through a digital infinite impulse response filter to produce a digital signal I_{MSdig} which has a value representative of the mean squared current through the electrical path; and
applying a square root operation to the digital signal I_{MSdig}.

22. A circuit protection device according to claim 2 wherein the digital processor is adapted to produce a digital signal P_{Adig} by multiplying the value of the digital signal I_{RMSdig} by the value of the digital signal V_{RMSdig}.

23. A circuit protection device according to claim 2 wherein the digital processor is adapted to produce the digital signal P_{Rdig} by:
producing a digital signal IV_{dig} by multiplying the value of the digital signal V_{dig} by the value of the digital signal I_{dig}; and
passing the digital signal IV_{dig} though a digital infinite impulse response filter.

24. A circuit protection device according to claim 1 wherein the digital processor is adapted to update the digital signals I_{dig} at a first frequency, V_{dig} at a first frequency, and optionally IV_{dig} at a first frequency.

25. A circuit protection device according to claim 24 wherein said first frequencies are at least 1 kHz.

26. A circuit protection device according to claim 1 wherein the digital processor is adapted to update the digital signal I_{Rdig} at a second frequency, and optionally any one or more of the digital signals I_{Adig} at a second frequency, V_{RMSdig} at a second frequency, I_{RMSdig} at a second frequency, P_{Adig} at a second frequency, P_{Rdig} at a second frequency, k_{dig} at a second frequency and/or θ_{dig} at a second frequency.

27. A circuit protection device according to claim 26 wherein said second frequencies are between 50 Hz and 120 Hz.

28. A circuit protection device according to claim 1 wherein:
the digital processor is adapted to update the digital signals I_{dig} at a first frequency, V_{dig} at a first frequency, and optionally IV_{dig} at a first frequency;
the digital processor is adapted to update the digital signal I_{Rdig} at a second frequency, and optionally any one or more of the digital signals I_{Adig} at a second frequency V_{RMSdig} at a second frequency I_{RMSdig} at a second frequency P_{Adig} at a second frequency P_{Rdig} at a second frequency, k_{dig} at a second frequency and/or θ_{dig} at a second frequency; and
the second frequencies are less than said first frequencies.

29. (canceled)

30. A circuit protection device according to claim 1 wherein the signal processing unit additionally has a first analogue to digital converter and a second analogue to digital converter;
wherein the first analogue to digital converter is adapted to:
receive an analogue signal Iₐₙ representative of the current through the electrical path; and
produce the digital signal I_{dig} based on the analogue signal Iₐₙ, for receiving in the digital processor
and wherein the second analogue to digital converter is adapted to:
receive at least one analogue signal Vₐₙ representative of the voltage across said electrical path; and
produce at least one digital signal V_{Xdig} based on the at least one analogue signal Vₐₙ, for in the digital processor for producing V_{dig} therefrom.

31. (canceled)

32. (canceled)

33. (canceled)

34. A circuit protection device according to claim 1 wherein the electrical supply is an AC electrical supply or a three phase AC electrical supply and the digital processor is adapted to produce the digital signal I_{Rdig} for each phase of the electrical supply.

35-38. (canceled)

39. A device for measuring a current through an electrical path, the device having a signal processing unit which includes a digital processor which is adapted to:
receive a digital signal I_{dig} which has a value representative of the current through the electrical path;
receive a digital signal V_{dig} which has a value representative of the voltage across the electrical path; and
produce a digital signal I_{Rdig} which has a value representative of the real component of the current through the electrical path, based on the digital signals I_{dig} and V_{dig}.
